(19) United States
(12) Patent Application Publication
(10) Pub. No.: US 2010/0181084 A1
(43) Pub. Date: Jul. 22, 2010

(54) BLOCKING COMPOSITION AGAINST FIRE ACTION AND ADVANCE IN DIVERSE SURFACES, MANUFACTURING AND APPLICATION PROCESS THEREOF

(76) Inventor: Hélio Maurício do Carmo, Jaragua do Sul (BR)

Correspondence Address: Mark Levy;HINMAN, HOWARD & KATTELL, LLP, 80 Exchange Street, P.O. Box 5250, BINGHAMTON, NY, 13901, US

(21) Appl. No.: 12/669,639

(22) PCT Filed: Jul. 18, 2008
(86) PCT No.: PCT/BR08/00207

§ 371 Date: Jan. 19, 2010

(30) Foreign Application Priority Data
Jul. 20, 2007 (BR) PI0703236-6
Jun. 4, 2008 (BR) 15080002094

(51) Int. Cl. A62C 3/00; A62D 1/06

(52) U.S. Cl. 169/45; 252/4

(57) ABSTRACT

Blocking composition against fire action and advance in diverse surfaces, manufacturing and application process thereof, the present patent of invention, refers to a powered and/or granulated composition, which is partially diluted in water, blocking against advance, with fire extinguisher action, of long-term effect in various types of vegetation. Its manufacturing and its application process hinder the fire spread in bushes, forests and easy combustion and inflammability surfaces, and in rural residences, among others. The product has the advantages of being inert to the environment, not damaging to the soil, effluents, flora and fauna, strongly contributes to the reduction of the emission of polluting gases from blazes, its a product of low toxicity non-corrosive and biodegradable, that can be easily applied and it can even fertilize the soil when the former gets wet by rains.

The present patent of invention refers to a powdered and/or granulated composition which is partially diluted in water, blocking against advance, with fire extinguisher action, of long-term effect in various types of vegetation; its manufacturing and its application process hinder the fire spread in bushes, forests and easy combustion and inflammability surfaces, and in rural residences, among others. The product has the advantages of being inert to the environment, not damaging to the soil, effluents, flora and fauna. It strongly contributes to the reduction of the emission of polluting gases from blazes, it is non-corrosive and biodegradable, of low toxicity and it can be easily applied. It can even fertilize the soil when the former gets wet by rains.

Fires in jungles, forests and grasslands cause enormous damages each year. Not only is the direct loss due to such fires enormous, but the problems associated to soil erosion and watershed are also significant. To solve these problems are being in use long-term fire retardants that contain, beyond water, a chemical compound that effectively delays the flaming combustion even after the water has evaporated.

Actually, the chemical retardants most commonly used are ammonium salts, such as monoammonium orthophosphate, diammonium orthophosphate and condensed ammonium phosphate which exists in fertilizing solution. Such ammonium salts are used generally in aqueous solution to facilitate the spraying from mobile equipment in the soil or from aerial bombardment from an aircraft or helicopters. Functionally the water serves, first, as a carrier for the chemical retardants.

It is common practice to thicken the long-term retardants with additives to improve their potentialities in respect to placement or confinement on the target, being the target wood or other foliage that constitutes the fuel for the combustion. Such additives also can improve the retardants adherence to the fuel's surface; they can help to retain the humidity; can create a humidity barrier between the fuel and the flame; and can improve the deposition of the retardant in the fuel's surface.

In the aerial application of liquid material to prevent, to retard and suppress fires, such as those usually undertaken using aircraft, the prior art acknowledge that low viscosity solutions, when dropped from considerable elevations, generally tend to atomize and thereof can not be relied upon to descend with sufficient concentration in specific target areas. It has been found that liquid fire suppressors with high viscosity, for example, 500 to 2,500 centipoises and cohesive properties, when they are dropped form considerable elevations, tend to remain together in such way that they can be confined in a specific target area and will descend thereupon with sufficient concentrations to be effective.

As pointed out on the U.S. Pat. No. 3,196,108, the majority of the thickeners agents to increase the viscosity and cohesive properties of aqueous solutions are not compatible with the most effective chemicals to fight against fire available.

Furthermore, it is stated that therein many of the chemical fire retardants which are compatible with some thickeners possess a low fire retarding capacity, in such way that is necessary to utilize great amounts of these materials. It is also been found, according to the U.S. Pat. No. 3,196,108, that some of the utilized fire retardants are effective when are humid, but with little or without effectiveness when are dry.

Among the additives known in use for modifying the rheological properties of ammonium phosphate solutions there is the galactomannan gums, sometimes called as polygalactomannan. U.S. Pat. No. 3,634,234 discloses the use of galactomannan gums in such solutions. The galactomannan materials are polyssaccharides, generally named hemicelluloses, and are long chain polymers of galactose and mannose units. They are gum like materials usually found in plant seeds. Are examples of galactomannan: guar gum, locust bean gum, and tara gum.

Recently, a composition of fire retardant appeared, industrialized by the U.S. company ICL Performance Products LP, which is used for fire control in native vegetation in forests, jungles and grasslands. This fire retardant reacts and modifies the thermal decomposition of native forest fuel in such way that they cannot stand the flaming or the glowing combustion. This deprives the fuel of the fire, reducing the fire intensity and the flame spread rate. These fire retardants are concentrated liquids that quickly mix with water, and the composition is a mixture of ammonium polyphosphate, Attapulgite clay, iron oxide and performance additives.

Briefly, we can find gel and liquids products to retard the advance of fires in forests and gel products for protection of residences, when the latter is in the eminence of being set on fire. The products found in the market do not present effectively result in the application, with limitations to hinder the total advance of fire and offering manipulation risks to ocular and skin toxicity and irritability, as informed in there informative bulletins; they are applied in greats amounts in the same area and still retard the fire in a short-term; moreover, the current products have expensive cost of production.

The present patent of invention refers to a powdered and/or granulated composition which is partially diluted in water, blocking against fire advance, with extinguisher action in various types of vegetation; its manufacturing and its application process intent is to hinder the fire propagation in bushes, forests and easy combustion and inflammability surfaces, rural residences, and so on.

The composition of the present patent is easily applied by aircraft or pressure spray over the substrate and the soil. It aims to block the fire advance, and suppress fire, differing itself from others for the great benefit of complete extinguishment of fire advance and contributing with soil fertilization, when it is carbonized by fire or gets wet by rains. Once sprayed, it adheres to the surface where it is applied over, either vegetation or soil, creating a uniform barrier interconnected by micro particles of solids from the composition, supplying a great fire and heat resistance, providing great fertilizing effect.

The composition of the present patent has the advantages of needing only a pair of glasses as individual protection equipment during the application, being a low toxicity non-corrosive product, being a fertilizing and biodegradable product; easy to apply even with manual equipments such as costal bombs, presented in powdered and/or granulated forms, adequate to the international logistics of forest fire combat, and its application equipments can be cleaned in lakes and rivers, without any damage to the environment.

The product of this patent acts as a long-term chemical agent destined to the direct or indirect fight measures against forest fire, with blocking and extinguisher action of fire, being also used preventively on defending interest areas by the construction of chemical firebreaks. Inert to the environment, it does not damage the soil, effluents, flora and fauna, and strongly contributes to the reduction of the emission of polluting gases from blazes.

The product fulfils the world demand for obtaining, effectively, the extinction of forest fire with a product that fits the laboratorial and practical results, permitting a way to control, manipulate and extinguish forest fires. Laboratorial results concluded that the product is easily biodegradable, favors the manipulation based on the results of sharp dermal and ocular irritability and still, referring to its impact to fish and earthworms, its excellence is not affected, it is comprehended that through its raw material does not permit damage to the soil, vegetables and animals. It is of easy solubility and appliance. The product hinders the fire advance and its devastation, creates a chemical non-polluting barer, promotes life by hindering the death of diverse species and subspecies, collaborates effectively with the lack of emission of polluting gases to the atmosphere, preserving the environment. Its adherence action allows that even without fire the product resists to bad weather, that only by fire or wetting it loses its efficiency, that is, fog or sun do not break its protecting function during a minimum of 15 days. The product that has not been consumed while blockade, and fire extinguishment, and which contains fertilizers originally present in its composition, will have the additional function of fertilizing the plants which were protected of fire through rains and purposeful wetting, bringing another advantage to the product of this patent, related to the prior art.

For better understanding the present patent the following figures are annexed:

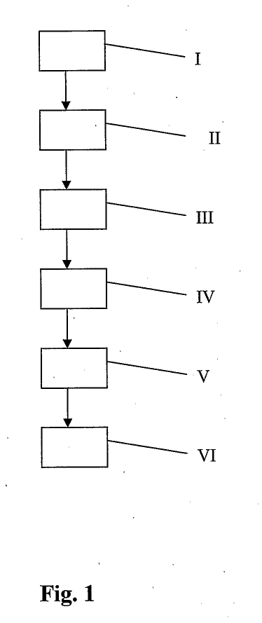

FIG. 1, shows the block diagram of the manufacturing process of the powdered and/or granulated composition of the present patent;

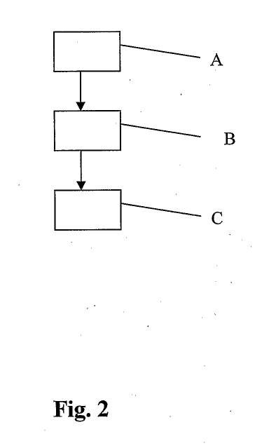

FIG. 2, shows the block diagram of the application process of the powdered and/or granulated composition of the present patent;

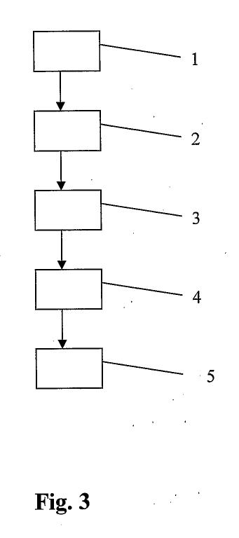

FIG. 3, that shows the block diagram of the alternative of manufacturing process of the powder and/or granulated composition of the present patent;

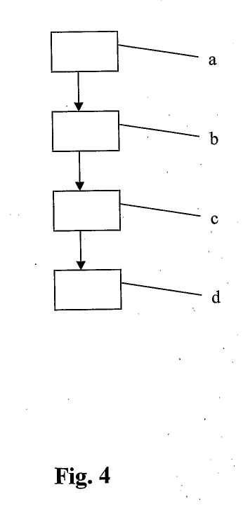

FIG. 4, shows the block diagram of the manufacturing process of the mixture of soap and the excess stabilizing of the present patent.

In a previous research of the blocking composition against fire advance and fire action, component alternatives have been studied based on the following premises.

1. The presence of one or more adherence promoters;

2. The presence of one or more thickener, capture and fixer of ashes;

3. The presence of one or more nitrogenous gases generator fertilizers;

4. The presence of one or more lubricant, to facilitate the application of the composition over the substrate and over the soil;

5. The presence of one or more density increaser; and

6. The presence of one or more composition stabilizers.

It has been noted on this first research that during the utilization of the said composition over the substrate or over the soil and in the presence of fire beside, the following mechanism of action occurs:

A. Penetration and adherence of the composition in the substrate by ungreasement and fluidity, given by the adherence agent, fixing the composition in the substrate and in the soil, preventing the dissolution by the humidity;

B. Cooling of the environment by endothermic chemical reactions and gaseous desorption; and

C. Generating ammonium gases and carbon dioxide (carbonic gas), reducing the oxygen concentration and interrupting the triangle of the fire.

In addition it has been noted that in the utilization of the composition as fire extinguishing, occurs additionally, the capture and control of the ascension of ashes avoiding the transmission or propagation of the fire to another areas.

Briefly, the first research revealed a powdered and/or granulated composition made of one or more adhering substances, lubricating and density increaser, one or more thickeners, viscosity regulators, ashes capturers and fixers, one or more gases generator fertilizers and one or more composition stabilizers.

The adherence agent, lubricant and density increaser of the composition is one or more vegetal oil soaps, preferentially the ricinic oil.

The thickener, viscosity regulator, ashes capturer and fixer of the composition is an adsorbent of the phyllosilicates family, from mineral origins, preferentially sodium bentonite.

The gas generator nitrogenous fertilizer of the composition is a nitrogenous molecular or composed organic fertilizer, preferentially urea.

The stabilizer of the composition is an organic surfactant preferentially the sodium dodecylbenzene sulphonate and/or triethanolamine dodecylbenzene sulphonate.

The beginning of the research had been carried exhausting qualitative and quantitative tests of compositions, whose results we describe succinctly as follows

Test No. 1

It was searched as adherence agent, lubricant and density increaser of the composition; vegetal oil soaps, obtained from soy oil, ricinic oil (Castor oil), palm's oil, peanut's oil and cotton seed's oil, all with good results; however we have accomplished better results using the ricinic oil soap. In the manufacturing of the said soaps we had tested the use of strong alkalis, sodium and potassium hydroxide on stequiometric quantities. Quantitatively, the best result for the soap in the composition occurred with 5.15% in mass, being able to occur variations from 4.00% to 7.00% in the composition. Researches had showed that these variations afford the solubility of the composition and leave the solids in suspension inside the solution, facilitating the dispersion. It was verified that values inferiors that values inferiors then 4.00% are not adequate for the solubility, the solids precipitate to the deep of the solution and compromise the objective of the composition. Values from 4.00% to 7.00%, contribute for the solubility, dispersion and density regulation and values above of the maximum indicated in the confection of the powdered and/or granulated composition, react and modify the structure forming instead of powder and/or granulated a rigid mass.

Test No. 2

It was searched as thickener, viscosity regulator, capture and fixer of ashes, adsorbent materials form mineral origin in special from the family of phyllosilicates, with excellent results for the sodium bentonite, because its particular thixotropic characteristics. Quantitatively, the best result for the thickener in the composition occurred with 23.20% in mass, being able to occur with variations from 12.00% to 30.00%. These values do not compromise the waited behavior of the thickener, however the use of values above of the indicated variation, turns the solution more consistent and decanted deposits occurs fast and in case of storing the solution for long periods, approximately 4 months, specified for this type of product occurs the material's hardening, damaging its utilization. The use of values inferiors of 12.00% compromise the thickness of the composition.

Test No. 3

It was searched as nitrogenous fertilizer gas generator, the organic nitrogenous fertilizer urea with excellent results for its particular characteristics of composition and chemical reactions of decomposition in high temperatures and alkaline environment. It was observed that its decomposition generates carbonic gases and ammonia that banish the oxygen and interrupt the fire, beyond cooling the environment due the endothermic chemical reactions and the gaseous desorption. Quantitatively, the best result for the fertilizer in the composition occurred with 71.51% in mass, being able to occur variations from 40.00% to 80.00% in the composition. During the use of values inferiors then 40.00%, the material in solution does not offer together with the soap in the composition sufficient cooling of the environment. Values above of 80.00%, does not bring better proportional results, raising the composition and compromising the balance of the same one.

Test No. 4

It was searched as stabilizer of the composition, organic surfactants, with good results when using the conventional derivates from sulphonic acid and from lauryl ether sulfuric acid, however the use of a soap as adherence agent lubricant and density increaser of the composition, it was decided to test sulphonic acid surfactants and produce then at the same time that the soap is produced. Thus the best results were accomplished by using the sodium dodecylbenzene sulphonate alone and/or triethanolamine dodecylbenzene sulphonate. Quantitatively, optimum results of additive was of 0.14% in mass, being able to occur variations from 0.10% à 0.18%. In case of different values of the related variation, it was observed that values inferiors 0.10% causes a disequilibrium of the prepared aqueous solution with the composition. And higher values from 0.18% cause additive excess without developing more stability and also increasing the costs.

Based on the results above mentioned, the optimized formularization of the composition is the following:

| | |
|---|---|
| Ricinic oil soap | 4.00 a 7.00% |
| Sodium bentonite | 12.00 a 30.00% |
| Technical urea | 40.00 a 80.00% |
| Triethanolamine dodecylbenzene sulphonate | 0.10 a 0.18% |

The manufacturing process of the composition, on the first research, occurs through the following steps:

1. In an equipment to mix powders, such as mixer and planetariums mixer, a thickener, capturer and fixer of soot the adsorbent phyllosilicate, and an organic fertilizer are added.

2. The substances are well mixed, for 5 minutes;

3. Alongside, vegetal oil soap is prepared, by adding vegetal oil in the reactor and subjecting it to heating in a range of 60° C. to 70° C. and during the heating and stirring, add the strong alkali and water in small doses and adds the amine during the initial heating stirring constantly;

4. The adherence agent, lubricant and density increaser, vegetal oil soap and organic surfactant stabilizer, are added slowly to the mixture, after total addition of the substances the composition is mixed for 40 minutes; and

5. The mixture is transferred in mill balls to decrease the size of particles until it becomes a fine powder.

Optionally, the mixture of the vegetal oil soap and the stabilizer(s) could be previously manufactured in the following sequence:

a. The vegetal oil is added in the reactor and is heated from 60° C. to 70° C.;

b. During the heating and under agitation, the strong alkali and the water are added in small dosages and the amine is also added during the initial heating under constant agitation;

c. The sulphonic acid is added without heating, after the addition of the alkali, with reaction time of 30 minutes; and

d. The components are cooled off.

The application process of the composition on the first research of the present patent is carried through the following:

A. The solution is prepared by diluting the powdered and/or granulated composition in water, on a proportion of 0.5 to 30 g/liter in a tank with a spade, manual or mechanically, transferring it to a costal spray applicator or to an aircraft spray applicator;

B. Applies the amount of 2 to 4 liters of the solution per square meter of area to be protected, forming a uniform layer over the surface; and

C. The fluid penetrates and instantaneously adheres to the surface creating a serous and contaminants dislocating skin, which hinders direct contact with fire, and leaves heat and radiation resistant particles in suspension.

On researches and additional essays that aimed for improving the product's efficiency and substituting its components by components which are less injuring to the environment, the best results on the products application have been obtained when it is presented with the following formulation:

| | |
|---|---|
| Technical urea | 15.00% to 55.00% |
| Ammonium sulfate | 12.50% to 60.00% |
| Sodium bentonite | 12.50% to 26.00% |
| Ricinic Oil | 3.50% to 7.00% |
| Triethanolamine | 0.00% to 1.00% |

The technical justifications that established the percentage range of each component were the following:

It's been observed that the preferential value for the component sodium bentonite in the formula is of 17.80%. This value could vary, without compromising the component's purpose, from 12.50% to 26.00%, which is explained by laboratorial tests with practical evaluation of observation and scientific proof within the components objective regarding humidity absorption and lubricity. This component in the formula aims to encapsulate the components of the ricinic oil and thrietanolamine by absorption and still, allow the suspension of the solids present in the formula when this one is placed in the aqueous solution. This components' function is of covering and casing the solids on the compositions' manufacturing, and also of capturing and fixing ashes and lubricant on the products' application. While using lower values than the established range, the precipitation and liberation of the ricinic oil and anticipated reaction of the triethanolamine alcalinity on the urea and ammonium sulfate components occurs and also, occurs the weakening of the resistance to the first contact with fire. This means that ricinic oil and triethanolamine shouldn't be left free and in its liquid form, as it would anticipate the reaction with the components urea and ammonium sulfate. The mineral origined phylosilicate has been tested with great results: aluminum silicate with same amounts of the sodium bentonite and in substitution of this one. Vegetal gums have been tested showing great results, as an example guar gum on partial substitution of the phylosilicate in percentages on the phylosilicate varying from 10% to 40%.

It's been observed that the preferential value of the component ricinic oil is 4.00%. This value might vary from 3.50% to 7.00% without changing this components' main objective, which is explained with laboratorial tests, with practical observation evaluations and scientific proof according to its proposal. Other vegetal oils have been tested, such as soy oil, palm oil, peanut oil, cotton seed oil, in equivalent quantities to the ricinic oil, all showing good results. The presence of this component is important to the retention of the solids after prepared the solution and its application, when the present water evaporates, leaving only the present solid components. The oils have the function of covering the solids and making it impermeable during its manufacture and, works as lubricator and adherence agent on its application against a substrate subjected to fire. This component is applied so that these solids will not lose its characteristics and will get fixed on the surface. Another important observation is that this component presents water resistance once out of the solution, which means that the air humidity and bad weather will not have influence on its function, only rain or real wetting will. According to what's been observed in laboratorial and practical tests, on values that are lower than the preference there is not a necessity to decrease or increase the amount of the sodium bentonite component, only for the values which are superior to the preference the percentage should be proportionally risen. An important observation is that values which are higher than the indicated maximum, will influence on the result when combating the fire, instead of resisting it will become a fuel from a certain high temperature. It also has been observed that the ricinic oil is a great substitute to the use of vegetal oil soaps.

It's been observed that the presence of the technical urea on formula has preferentially the value of 37.00%. This value could suffer variations between 15.00% to 55.00% without interfering on this components proposal in the formulation. This component has an active element function on the chemical reaction, of liberating ammonium gases and carbonic gas, and, through reaction with high temperatures and with triethanolamine they will substitute the oxygen on the fire triangle, interrupting it. According to what's been observed in laboratorial and practical tests, on inferior values according to the preference, the amount of gases is not sufficient to substitute oxygen on the fire triangle, and on superior values referring to the maximum indicated, there will be an stequiometric imbalance on the chemical reaction and there will be left a residual of the component.

It's been observed that the presence of the ammonium sulfate in the formulation is preferentially of 40.45%. This value could vary between 12.50% to 60.00% without interfering on the proposal of this component in the composition. This component has an active element function on the chemical reaction, of liberating ammonium gases and carbonic gas, and. through reaction with high temperatures and with triethanolamine they will substitute the oxygen on the fire triangle, interrupting it. Besides that, when chemically decomposed, balances the pH of the media, making it less alkaline. According to what's been observed in laboratorial and practical tests, on inferior values according to the preference, the amount of gases is not sufficient to substitute oxygen on the fire triangle, and on superior values referring to the maximum indicated, there will be a stequiometric imbalance on the chemical reaction and there will be left a residual of the component.

It's been observed that the presence of the triethanolamine on the composition is optional, can be added or not with the water of the suspension preparation, immediately before the products application, and shows the preferential value of 0.75%. This value could vary between 0.00% to 1.00% without interfering on the proposal of this product, and attending to the proposed formulation. This component's action occurs by the reaction with the formula's components, urea and ammonium sulfate. Once the triethanolamine is absorbed in the bentonite, it loses its momentary action of using the decomposition reaction of urea and ammonium sulfate, because it is found on its dried form absorbed in the sodium bentonite, only reacting completely and preserving its proposal when the aqueous solution of the product is made immediately before the utilization. During the manufacturing of the component the triethanolamine reacts with the ricinic oil, which also absorbed in the bentonite previously, forming amine salt of ricinic oil, facilitating its solubility in the solution and stabilizing the pH on 7.00 for a long period. The solution will remove the natural protection of the substrate and will replace it by adherent covering proposed to the present finality of the formula's components. The use of bigger quantities than the highest value will cause a rise on the pH, increasing the alkalinity and anticipating the decomposing reaction of urea and ammonium sulfate, and will also cause corrosion.

On researches and additional tests the manufacturing process of the composition follows the sequence below (steps):

I) The component technical urea is added and is left under agitation, in a turbo homogenizer mixer or ribbon blender, so it can follow the 2^{nd} step;

II) Keeping it under agitation, pour in slowly all the ammonium sulfate and leave it under agitation during a minimum of 5 minutes, and only then the 3^{rd} step should be taken;

III) Verifying and reassuring that the 1st and 2nd steps have been well succeeded, and still keeping both under agitation, slowly add all the ricinic oil component and/or soy oil and/or palm oil and/or peanut oil and/or cotton seed oil on the mixture and leave it under agitation during a minimum of 10 minutes so that the components will be completely absorbed;

IV) Pour the sodium bentonite component and/or aluminum silicate and/or guar gum, into all the mixture from the 3rd step and agitating to a homogenization of the components, leaving it under agitation during a minimum of 5 minute;

V) In case it is being used, add the triethanolamine component in the mixture from the 4th step and agitate it in order to get a perfect mixture and homogenization of the components, and then leave it under agitation during 10 minutes; and

VI) Pack it manually or using an appropriate machine, in sealed plastic bags with a valve.

The product, obtained on the researches and additional tests presents the following specifications:
Presentation: Powdered and/or granulated solids mixture.
Water Solubility: the biggest part of the components are quite soluble, a part of the additives easily stays in suspension.
Color: Milky white, orange or red
Apparent Density: 0.8 a 1.0 g/cm³
Utilization Form Diluted in water.
Stability of the suspension in water: Keep it under light agitation.
pH: slightly alkaline

Recommended dilution: 17.5% p/p.
Output:
   212 grams of product for each liter of pure water.
   20 kg of product for every 94 liters of pure water.
   Density of the solution: 1.05 g/cm³.

The application process of the present patent, on the additional research is carried out as described below:

A. The solution is prepared by diluting the powdered/and or granulated in water, on a proportion of 0.5 to 30 g/liter in a tank with a spade, manual or mechanically, transferring it to a costal spray applicator or to an aircraft spray applicator.

B. It is used a quantity of 2 to 4 liters of the solution for each squared meter of area to be protected, forming a uniform cover over the surface; and

C. The fluid penetrates and instantaneously adheres to the surface creating a serous and contaminants dislocating skin, which hinders direct contact with fire, and leaves heat and radiation resistant particles in suspension.

The products' mechanism of action occurs after the application of the aqueous suspension over the vegetal substrate and the soil, forming a barrier against the flow of the fire. When the fire reaches the layer where the product was applied, the flames lose intensity almost immediately and go off. The product's effectiveness results from the chemical and physical reaction caused by the contact of fire and the product spreaded on the substrate, through the following mechanism:

aa. Adherent and surfactant agents fix the product on the substrate and hinder the water evaporation;

bb. The gases generated by the products reaction when heated dislocate the oxygen from the air together with the substrate, taking one of the components off from the fire triangle; and

cc. The hot ashes (sparks) are fixed together with the substrate, eliminating one of the main forms of propagation of new uncontrolled fire spots.

1. BLOCKING COMPOSITION AGAINST FIRE ACTION AND ADVANCE IN DIVERSE SURFACES, characterized by, one or more vegetal oil or vegetal oil soap acting as adherence promoters and lubricant, one or more phyllosilicates from mineral origin acting as thickener, viscosity regulator, capturer and fixer of ashes, one or more nitrogenous gases generator fertilizers and/or one or more amine salts of vegetal oil and/or sulphonic acid salts acting as composition stabilizers.

2. BLOCKING COMPOSITION AGAINST FIRE ACTION AND ADVANCE IN DIVERSE SURFACES, in accordance with claim 1, characterized by, the substance being the adherence agent and lubricant of the composition, ricinic's oil, and/or soy oil and/or palm oil and/or peanut oil and/or cotton seed oil.

3. BLOCKING COMPOSITION AGAINST FIRE ACTION AND ADVANCE IN DIVERSE SURFACES, in accordance with claim 1, characterized by, thickener, viscosity regulator, and ashes capturer and fixer of said composition being the sodium bentonite and/or aluminum silicate and/or guar gum.

4. BLOCKING COMPOSITION AGAINST FIRE ACTION AND ADVANCE IN DIVERSE SURFACES, in accordance with claim 1, characterized by, more nitrogenous gases generator fertilizers of said composition being technical urea and/or ammonium sulfate.

5. BLOCKING COMPOSITION AGAINST FIRE ACTION AND ADVANCE IN DIVERSE SURFACES, in accordance with claim 1, characterized by, the composition stabilizer being amine salts of ricinic oil and/or soy oil and/or palm oil and/or peanut oil and/or cotton seed oil.

6. BLOCKING COMPOSITION AGAINST FIRE ACTION AND ADVANCE IN DIVERSE SURFACES, in accordance with claim 1, characterized by, optimized formulation with: 15.00% to 55.00% of technical urea; 12.50% to 60.00% of ammonium sulfate; 12.50% to 26.00% of sodium bentonite; 3.50% to 7.00% of ricinic oil and 0.00% to 1.00% of triethanolamine.

7. BLOCKING COMPOSITION AGAINST FIRE ACTION AND ADVANCE IN DIVERSE SURFACES, in accordance with claim 1, characterized by, the adherence promoter, lubricant and density increaser of said composition being ricinic oil soap and/or soy oil and/or palm oil and/or peanut oil and/or cotton seed oil.

8. BLOCKING COMPOSITION AGAINST FIRE ACTION AND ADVANCE IN DIVERSE SURFACES, in accordance with claim 1, characterized by, the composition stabilizer being sodium dodecylbenzene sulphonate and/or triethanolamine dodecylbenzene sulphonate.

9. BLOCKING COMPOSITION AGAINST FIRE ACTION AND ADVANCE IN DIVERSE SURFACES, in accordance with claim 1, characterized by, optimized formulation with: 4.00 to 7.00% of de ricinic oil soap; 12.00 to 30.00% of sodium bentonite; 40.00 to 80.00% of technical urea; 0.10 a 0.18% of triethanolamine dodecylbenzene sulphonate.

10. MANUFACTURING PROCESS of said composition cited in claim no. 1, characterized by, the following sequence:
I) The component technical urea is added and is left under agitation, in a turbo homogenizer mixer or ribbon blender, so it can follow the 2^{nd} step;
II) Keeping it under agitation, pour in slowly all the ammonium sulfate and leave it under agitation during a minimum of 5 minutes, and only then the 3^{rd} step should be taken;
III) Verifying and reassuring that the 1st and 2nd steps have been well succeeded, and still keeping both under agitation, slowly add all the ricinic oil component and/or soy oil and/or palm oil and/or peanut oil and/or cotton seed oil on the mixture and leave it under agitation during a minimum of 10 minutes so that the components will be completely absorbed;
IV) Pour the sodium bentonite component and/or aluminum silicate and/or guar gum, into all the mixture from the 3rd step and agitating to a homogenization of the components, leaving it under agitation during a minimum of 5 minute;
V) In case it is being used, add the triethanolamine component in the mixture from the 4th step and agitate it in order to get a perfect mixture and homogenization of the components, and then leave it under agitation during 10 minutes; and
VI) Pack it manually or using an appropriate machine, in sealed plastic bags with a valve

11. APPLICATION PROCESS of said composition cited in claim no. 1, characterized by, the following sequence:
A. The solution is prepared by diluting the powdered and/or granulated composition in water, on a proportion of 0.5 to 30 g/liter in a tank with a spade, manual or mechanically, transferring it to a costal spray applicator or to an aircraft spray applicator;
B. Applies the amount of 2 to 4 liters of the solution per square meter of area to be protected, forming a uniform layer over the surface; and
C. The fluid penetrates and instantaneously adheres to the surface creating a serous and contaminants dislocating skin, which hinders direct contact with fire, and leaves heat and radiation resistant particles in suspension.

12. MANUFACTURING PROCESS of said composition cited in claim no. 1, characterized by, the following sequence:
1. In an equipment to mix powders, such as mixer and planetariums mixer, a thickener, capturer and fixer of soot the adsorbent phyllosilicate, and an organic fertilizer are added;
2. The substances are well mixed, for 5 minutes;
3. Alongside, vegetal oil soap is prepared, by adding vegetal oil in the reactor and subjecting it to heating in a range of 60° C. to 70° C. and during the heating and stirring, add the strong alkali and water in small doses and adds the amine during the initial heating stirring constantly;
4. The adherence agent, lubricant and density increaser, vegetal oil soap and organic surfactant stabilizer, are added slowly to the mixture, after total addition of the substances the composition is mixed for 40 minutes; and
5. The mixture is transferred in mill balls to decrease the size of particles until it becomes a fine powder.

13. MANUFACTURING PROCESS in accordance with claim 1, characterized by, optionally, the mixture of the vegetal oil soap and the stabilizer(s) could be previously manufactured in the following sequence:
a. The vegetal oil is added in the reactor and is heated from 60° C. to 70° C.;
b. During the heating and under agitation, the strong alkali and the water are added in small dosages and the amine is also added during the initial heating under constant agitation;
c. The sulphonic acid is added without heating, after the addition of the alkali, with reaction time of 30 minutes; and
d. The components are cooled off.
